(19) United States
(12) Patent Application Publication
(10) Pub. No.: US 2005/0204335 A1
(43) Pub. Date: Sep. 15, 2005

(54) Affinity regions on visual design surfaces

(75) Inventor: Jeremy Mercer, Woodinville, WA (US)

Correspondence Address: BANNER & WITCOFF LTD.,;ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/798,206

(22) Filed: Mar. 11, 2004

(51) Int. Cl. G06F 9/44

(52) U.S. Cl. 717/113; 717/105

(57) ABSTRACT

Methods and systems for representing characteristics of design elements on visual design surfaces are provided. Assorted design elements are represented by shapes on the visual design surface. Each shape may represent a different type of design element. A characteristic of a design element may be represented by placing an aura around the design element. A single shape may have several auras that represent different characteristics. Like auras may be merged to create affinity regions.

### FIELD OF THE INVENTION

Aspects of the present invention relate to visual design surfaces. More specifically, aspects of the present invention provide user interfaces for visual design surfaces that include visually perceptible indicators next to design elements to represent characteristics.

### BACKGROUND

Visual design surfaces are commonly used to illustrate and design systems using graphical notations. Microsoft Visio diagramming program, for example, includes a visual design surface that allows users to illustrate processes with flow charts. The shapes of the elements are used to represent different entities. A diamond shape, for example, may represent a decision process. Microsoft Visual Studio development system is another example of an application that includes a visual design surface. The visual design surface is used to model business processes.

One drawback of existing visual design surfaces is that the elements that represent different entities convey limited information to users. For example, several different decision processes may be represented with diamond shapes. Each of the decision processes may have characteristics that are important to the user. Decision making processes may be characterized as high importance, medium importance or low importance. With existing visual design surfaces it is not readily apparent to a user which decision processes have which level of the importance characteristic.

Therefore, there is a need in the art for visual design surface systems and methods that visually convey characteristics of design elements to users.

### BRIEF SUMMARY

Aspects of the present invention address one or more of the issues mentioned above, thereby providing methods of representing characteristics of design elements on a visual design surface. The methods include representing design elements with shapes on a visual design surface. One or more characteristics of the design elements may be represented with auras associated with the design elements. The auras allow users to quickly determine design element characteristics.

### BRIEF DESCRIPTION OF THE DRAWINGS

Aspects of the present invention are described with respect to the accompanying figures, in which like reference numerals identify like elements, and in which:

FIG. 1 shows a functional block diagram of a conventional general-purpose computer system;

FIG. 2 shows a method for use with a visual design surface to convey characteristics of design elements to users, in accordance with an embodiment of the invention;

FIG. 3 shows design elements surrounded by auras, in accordance with an embodiment of the invention;

FIG. 4 shows a visual design surface having merged auras, in accordance with an embodiment of the invention;

FIG. 5 illustrates a visual design surface having auras grouped into affinity regions, in accordance with an embodiment of the invention;

FIG. 6 shows a visual design surface having three affinity regions extending horizontally, in accordance with an embodiment of the invention;

FIG. 7 shows a visual design surface having affinity regions that include labels, in accordance with an embodiment of the invention; and

FIG. 8 shows a design element that includes multiple auras, in accordance with an embodiment of the invention.

### DETAILED DESCRIPTION

Exemplary Operating Environment

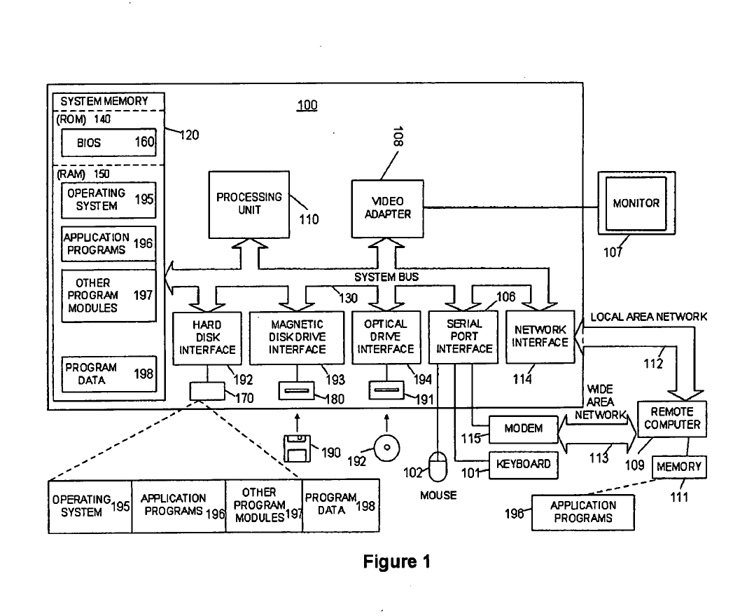

FIG. 1 is a functional block diagram of an example of a conventional general-purpose digital computing environment that can be used to implement a visual design surface in accordance with various aspects of the present invention. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor, personal computers typically include other peripheral output devices (not shown), such as speakers and printers.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are illustrative and other techniques for establishing a communications link between the computers can be used.

The existence of any of various well-known protocols such as TCP/IP, Ethernet, FTP, HTTP, Bluetooth, IEEE 802.11x and the like is presumed, and the system can be operated in a client-server configuration to permit a user to retrieve web pages from a web-based server. Any of various conventional web browsers can be used to display and manipulate data on web pages.

Description of Illustrative Embodiments

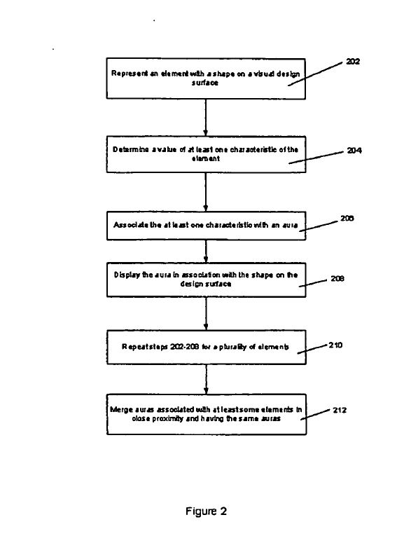

FIG. 2 illustrates a method for use with a visual design surface to convey characteristics of design elements to users. First, in step 202, a design element is represented with a shape on a visual design surface. FIG. 2 illustrates a visual design surface in which design elements are represented with rectangular shapes 302-308. Shapes 302-308 may represent such things as business processes, flowchart steps, hosting platforms, hardware components or other design elements.

Next, in step 204 the value of at least one characteristic of the design element is determined. Characteristics may include an identification of a namespace, an identification of an application layer, an identification of an importance level, an identification of an intended use or other characteristics. An aura is then associated with the characteristic in step 206. As used herein, an “aura” is a visually perceptible element that is placed next to, around or within a design element and that represents a characteristic of the element. Auras may include colored elements, patterned elements, symbols and the like.

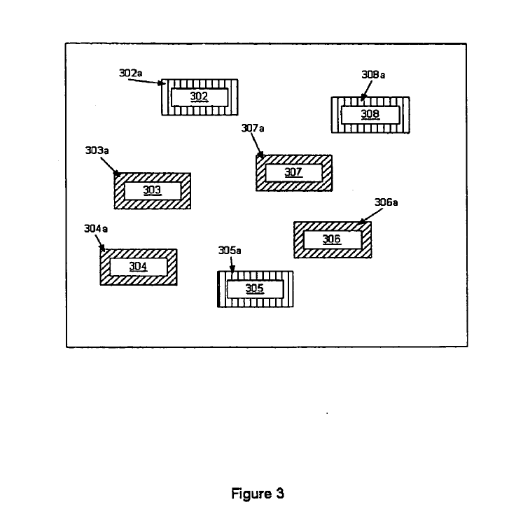

In step 208, the aura is displayed in association with a shape on the design. Two elements are displayed in association with one another, for example, when a viewer would recognize that there is a specific relationship between the elements. FIG. 3 shows elements 302-308 surrounded by auras 302a-308a, respectively. In an illustrative example, elements 302-308 may represent hosting environments for hosting a distributed system. Auras 302a-308a may correspond to security characteristics. For example, aura 302a may indicate that element 302 includes the characteristic of requiring secure sockets layer (SSL) protocol and aura 303a may indicate that element 303 requires a specific type of encryption.

In the embodiment shown in FIG. 3, a user can quickly identify the values of the relevant characteristics. For example, a user may quickly determine that elements 302, 305 and 308 require secure sockets layer (SSL) protocol and elements 303, 304, 306 and 307 requires a specific type of encryption.

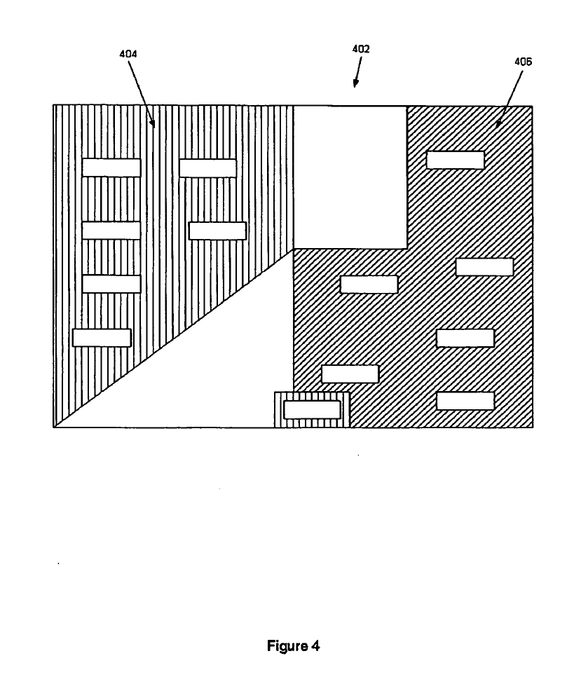

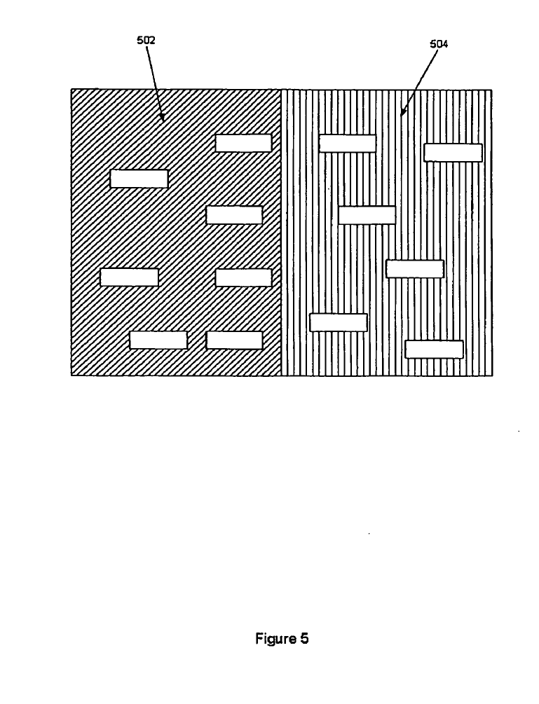

In step 210, steps 202-208 may be repeated for a plurality of design elements. The resulting design surface may look like the design surface shown in FIG. 3. Next, like auras of design elements in close proximity may be merged. FIG. 4, for example, shows a visual design surface 402 having merged auras 404 and 406. Merged auras 404 and 406 constitute affinity regions. An affinity region is a section of a visual design surface that contains design elements having a common characteristic represented by a common aura. It is well within the skill of a practitioner in the art to develop computer code that determines which design elements having the same auras are close to each other and to merge those auras. In another embodiment of the invention, design elements may be grouped into defined affinity region. FIG. 5 illustrates a visual design surface having two affinity regions 502 and 504. Each design element belongs either to affinity region 502 or affinity region 504. The size of an affinity region may be a function of the number of design elements included with the affinity region. This allows a developer to quickly visualize the relative numbers of design elements including the characteristics corresponding to the affinity regions.

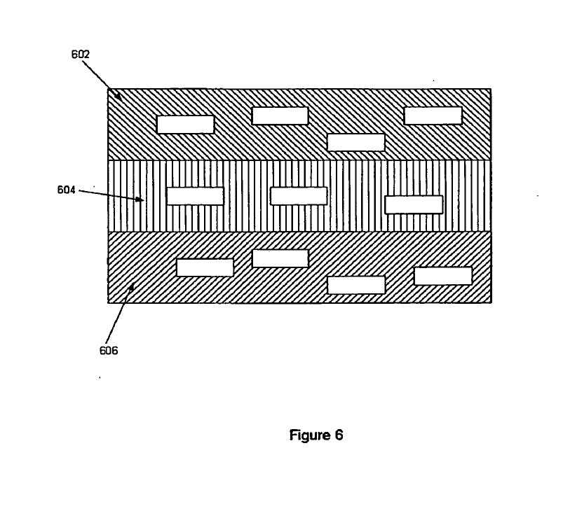

A visual design surface may utilize any number of affinity regions and the affinity regions may have a variety of shapes and orientations. FIG. 6 shows a visual design surface having three affinity regions 602, 604 and 606 extending horizontally.

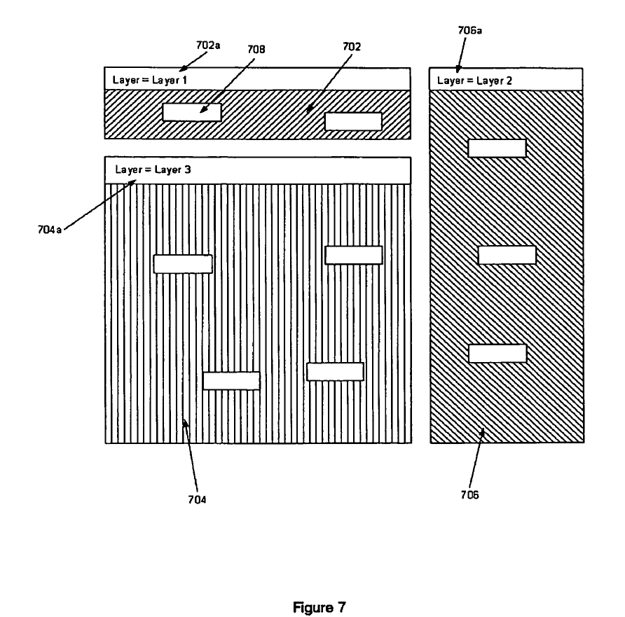

FIG. 7 shows an embodiment in which affinity regions 702, 704 and 706 include labels 702a, 704a and 706a. Labels may be used to identify the values of the characteristics represented by each affinity region. Label 702a, for example, indicates that all of the design elements included within affinity region 702 have a layer value of 1.

In one embodiment of the invention, the value of a characteristic of a design element may be changed by dragging the element from one affinity region and hovering the element over another affinity region. For example, the layer value of design element 708 may be changed from 1 to 2 by moving element 708 from affinity region 702 to affinity region 706 and hovering the element over affinity region 706 before dropping the element. Hovering means holding an object stationary during a drag and drop operation for a period of time before dropping the object. Of course predetermined key sequences, pointing device buttons, menu options, etc. may also be used to indicate that a characteristic of a design element is to be changed during a drag and drop operation.

Labels associated with affinity regions may also be used to change values of characteristics. For example, changing label 706a to read “Layer=Layer 3” will change all of the layer values for the design elements in affinity region 706 to 3.

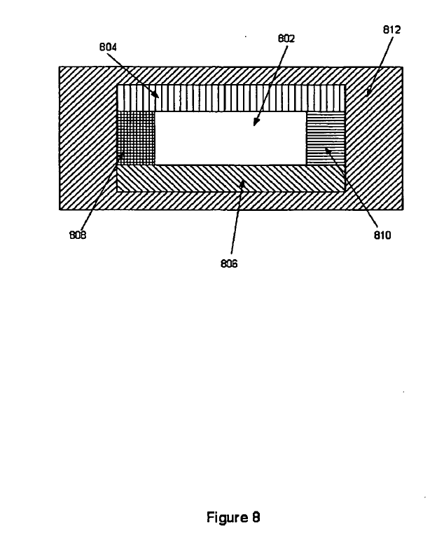

A visual design surface may be configured to allow a user to choose whether to display affinity regions, display labels, merge affinity regions, allow for changes in labels, etc. Moreover, a variety of different auras may be associated with design elements. FIG. 8 shows a design element 802 including auras 804, 806, 808, 810 and 812. The location or position of an aura may correspond to a particular characteristic. For example, aura 810 may represent a security characteristic and aura 812 may represent a hosting environment requirement.

The present invention has been described in terms of preferred and exemplary embodiments thereof. Numerous other embodiments, modifications and variations within the scope and spirit of the appended claims will occur to persons of ordinary skill in the art from a review of this disclosure.

1. A computerized method of representing at least one characteristic of a design element on a visual design surface, the method comprising:
(a) representing an element with a shape on a visual design surface;
(b) determining a value of at least one characteristic of the element;
(c) associating the at least one characteristic with an aura; and
(d) displaying the aura in association with the shape on the design surface.

2. The method of claim 1, wherein the aura comprises a color coded area surrounding the shape.

3. The method of claim 1, wherein the aura comprises a color coded area adjacent to at least a portion of the shape.

4. The method of claim 1, further including:
(e) repeating (a)-(d) for a plurality of elements; and
(f) merging auras associated with at least some elements in close proximity and having the same value of the characteristic.

5. The method of claim 1, further including:
(e) repeating (a)-(d) for a plurality of elements; and
(f) sorting the elements so that elements having the same characteristic are generally located in the same region.

6. The method of claim 5, further including grouping and displaying elements in affinity regions, wherein each affinity region represents elements having the same value of the characteristic.

7. The method of claim 6, further including providing a label for at least one affinity region that allows a user to change the value of the characteristic of all of the elements in the at least one affinity region by changing the label.

8. The method of claim 1, wherein the at least one characteristic comprises a use for the element.

9. The method of claim 1, wherein the at least one characteristic comprises an identification of a namespace.

10. The method of claim 1, wherein the at least one characteristic comprises an identification of an application layer.

11. The method of claim 1, wherein the at least one characteristic comprises an identification of an importance level.

12. The method of claim 1, further including:
(e) determining a value of at least a second characteristic of the element;
(f) associating the second characteristic with a second aura; and
(g) displaying the second aura in association with the shape on the design surface.

13. The method of claim 12, further including:
(h) determining a value of at least a third characteristic of the element;
(i) associating the third characteristic with a third aura; and
(j) displaying the third aura in association with the shape on the design surface.

14. In a computer system having a graphical user interface including a display and a user interface selection device, a method of changing at least one characteristic of an element displayed on a visual design surface, the method comprising:
(a) displaying on the display at least two affinity regions on a visual design surface, wherein each affinity region includes elements having the same value of a characteristic;
(b) receiving a movement command indicative of the user interface selection device dragging an element from a first affinity region and hovering the element over a second affinity region; and
(c) in response to (b), changing a value of the characteristic of the element in (b) from the value associated with the first affinity region to the value associated with the second affinity region.

15. The method of claim 14, wherein the characteristic of the element in (b) comprises a use for the element.

16. The method of claim 14, wherein the characteristic of the element in (b) comprises an identification of a namespace.

17. The method of claim 14, wherein the characteristic of the element in (b) comprises an identification of an application layer.

18. The method of claim 14, wherein the characteristic of the element in (b) comprises an identification of an importance level.

19. A computer-readable medium containing computer-executable instructions for performing the steps comprising:
(a) displaying on a visual design surface a design element shape; and
(b) displaying on the visual design surface an aura in proximity to the design element shape to represent a value of a characteristic.

20. The computer-readable medium of claim 19, wherein (b) comprises displaying the aura around the design element shape.
